(19) United States
(12) Patent Application Publication
(10) Pub. No.: US 2013/0339559 A1
(43) Pub. Date: Dec. 19, 2013

(54) METHOD TO CONTROL OPTICAL TRANSCEIVER IMPLEMENTED WITH A PLURALITY OF INNER SERIAL BUSES

(71) Applicant: SUMITOMO ELECTRIC INDUSTRIES, LTD., Osaka (JP)

(72) Inventor: Hiromi TANAKA, Yokohama-shi (JP)

(21) Appl. No.: 13/913,680

(22) Filed: Jun. 10, 2013

(30) Foreign Application Priority Data
Jun. 13, 2012 (JP) 2012-134068

(51) Int. Cl. G06F 13/40

(52) U.S. Cl. CPC G06F 13/4022
USPC 710/110

(57) ABSTRACT

An optical transceiver implemented with a plurality of inner serial busses is disclosed. One of inner serial busses is the mother serial bus drawn out from the controller to the bus selector, while, the rest are daughter serial busses connecting the bus selector to respective circuit units. When some circuit units causes failures to hang the daughter serial bus connected thereto, the controller makes this daughter serial bus inactive by controlling the bus selector, and collects information and sets parameters to rest circuit units as activating other daughter serial busses.

### BACKGROUND OF THE INVENTION

1. Field of the Invention

The present application relates to a method to control an optical transceiver that implements with a plurality of inner serial busses.

2. Related Background Arts

A United States patent, U.S. Pat. No. 7,359,643, has disclosed an optical transceiver implemented with an inner serial bus and a function to set itself in the power saving mode. When the serial bus implemented within an electronic apparatus couples with a plurality of circuit units and the electronic apparatus implements the function of the power saving, some of circuit units forces the serial bus in LOW state, which makes the other circuit units, to which power is supplied even when the power saving mode, impossible to communicate with the serial bus master.

### SUMMARY OF THE INVENTION

An aspect of the present application relates to a method to control an electronic apparatus, in particular, an optical transceiver that implements with a mother serial bus, a plurality of daughter serial buses each selectively coupled with the mother serial bus, and a plurality of circuit units each coupled with respective daughter serial buses. The method includes steps of: (1) selecting one of circuit units by providing power supply thereto; (2) selecting one of daughter serial busses coupled with the selected circuit units; and (3) communicating with the selected circuit unit by using the selected daughter serial busses. Because respective circuit units are coupled with the controller through one of daughter serial busses, the bus selector, and the mother serial bus; the controller may communicate with the target circuit units even when a daughter serial bus connected to another circuit unit is hung up by isolating the daughter serial bus connected to the target circuit unit from the hung up bus.

Another aspect of the present application relates to a configuration of an optical transceiver that is coupled with a host system. The optical transceiver comprises a plurality of circuit units, a bus selector, a controller, and a plurality of inner serial busses. One of inner serial busses is a mother serial bus to couple the controller with the bus selector, while the others are daughter serial busses each coupling the bus selector with respective circuit units. A feature of the optical transceiver of the present application is that the controller cuts a supplement of a power supply to at least one of circuit units and isolates one of daughter serial busses coupled to the at least one of circuit units by controlling the bus selector.

### BRIEF DESCRIPTION OF THE DRAWINGS

The invention may be more completely understood in consideration of the following detailed description of various embodiments of the invention in connection with the accompanying drawings, in which:

FIG. 1 is a functional block diagram of an optical transceiver according to an embodiment of the invention;

FIG. 2 extracts circuit units coupled with the inner serial busses;

FIG. 3 exemplarily shows a frame put on the mother serial bus connecting the controller to the bus selector;

FIG. 4 shows a time chart to switch the daughter serial busses by the bus selector according to the first embodiment;

FIG. 5 shows a time chart to switch the daughter serial busses by the bus selector according to the second embodiment; and

FIG. 6 extracts circuit units coupled with the inner serial busses and supplied with the power supply independent to respective circuit units.

### DETAILED DESCRIPTION OF PREFERRED EMBODIMENTS

Next, some embodiments according to the present application will be described as referring to drawings. In the description of the drawings, numerals or symbols same with or similar to each other will refer to elements same with or similar to each other without overlapping descriptions.

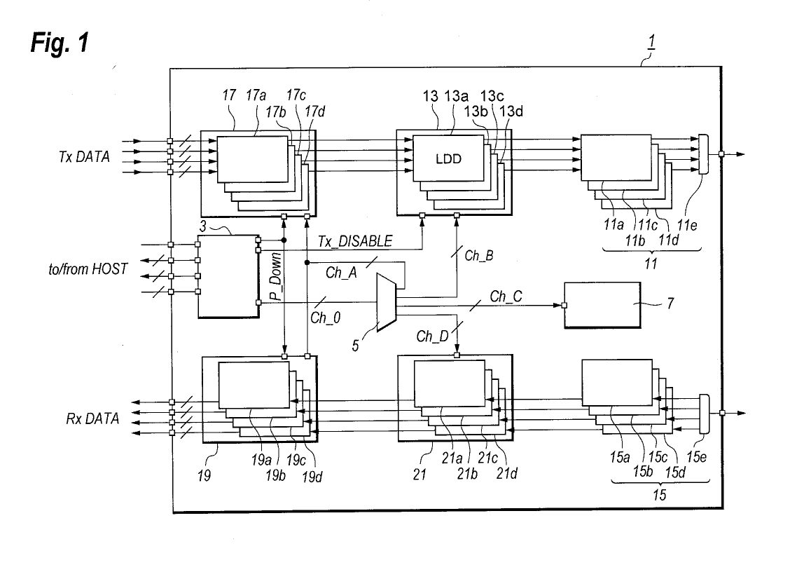

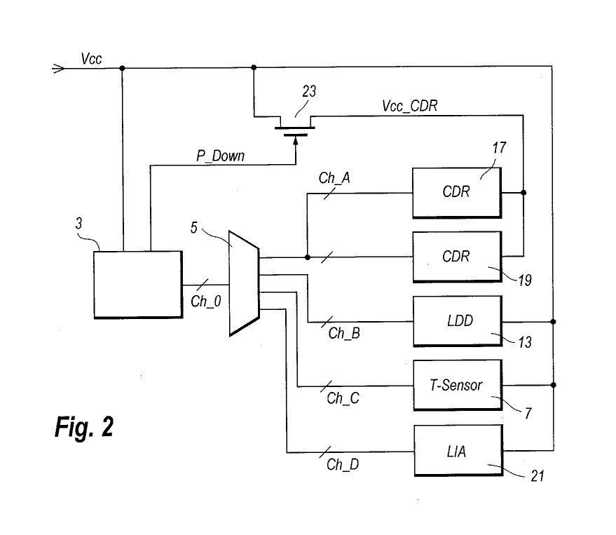

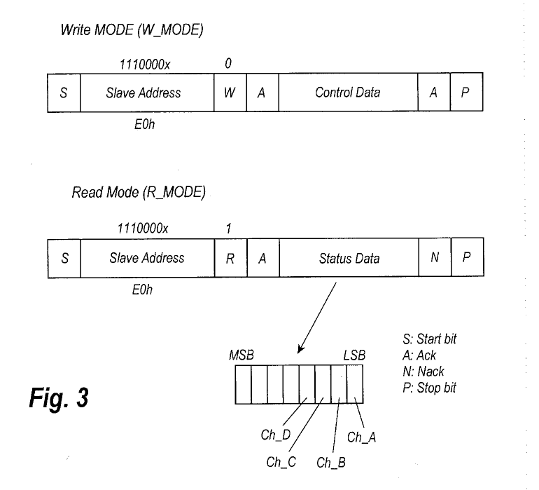

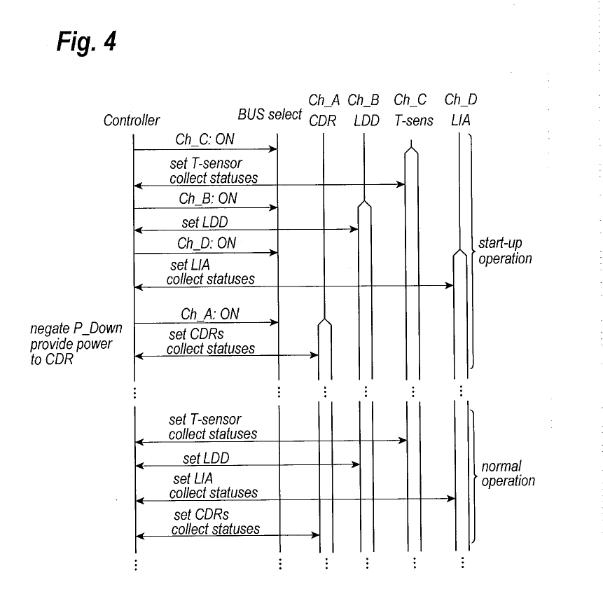

An optical transceiver according to one embodiment of the present invention is described as referring to FIGS. 1 to 4. FIG. 1 is a functional block diagram of an optical transceiver; FIG. 2 shows a block diagram of a portion to supply power to components in the optical transceiver; FIG. 3 shows sequences of the serial communication in the optical transceiver; and FIG. 4 shows time charts of switching the I²C buses.

The optical transceiver 1 shown in FIG. 1 converts signals between electrical one and optical one. The optical transceiver 1 will be set in an external system, which is often called as a host system, and is a type of, what we call, a pluggable transceiver. The optical transceiver 1 is coupled with an external connector that secures with optical fibers to transmit or receive optical signals. Thus, the optical transceiver 1 performs the full-duplex transmission.

The optical transceiver 1 primarily includes a controller 3, a bus selector 5, a temperature sensor 7, a transmitter optical subassembly (TOSA) 11, an laser diode driver (LDD) 13, a receiver optical subassembly (ROSA), two clock data recoveries (CDR), 17 and 19, and a limiting amplifier (LIA) 21. The TOSA 11, the LDD 13, the CDRs, 17 and 19, and the LIA 21 are electrically active circuit units. In addition, the optical transceiver 1 includes command lines, P_Down and Tx_DISABLE, and a plurality of internal serial buses, Ch_0 to Ch_D, where the specification below assumes the first serial bus Ch_0 coupling the controller 3 with the bus selector 5 is a mother serial bus, while, others, Ch_A to Ch_D, each couples respective circuit units with the bus selector 5 is daughter serial busses. All of serial busses, Ch_0 to Ch_D, follow the standard of, what we call, the I²C protocol.

The TOSA 11, the LDD 13, the ROSA 15, the CDRs, 17 and 19, and the LIA 21 have the arrangement of four (4) lanes. That is, the optical transceiver 1 may process four (4) channels of data. Two CDRs, 17 and 19, are able to be integrated in a single unit. Specifically, The CDRs in the first lane, 17a and 19a, may be integrally formed, the CDRs in the second lane, 17b and 19b, are integrally formed, and so on.

The TOSA 11 converts electrical signals into optical signals. That is, the TOSA 11 includes four laser diodes (LDs), 11a to 11d, and an optical multiplexer 11e. Respective LDs, 11a to 11d, couple with LDDs, 13a to 13d, corresponding to the LDs, 11a to 11d. The LDs, 11a to 11d, emit four optical signals responding to electrical signals each coming from the LDDs, 13a to 13d, and having specific wavelengths different from others. The optical multiplexer 11e multiplexes four optical signals provided from respective LDs, 11a to 11d, and outputs the multiplexed optical signal externally.

The LDD 13 includes four LDD units, 13a to 13d, each of which is internally coupled with the command line Tx_DISABLE and one of daughter serial bus Ch_B. Each of LDD units, 13a to 13d, is coupled with CDR units, 17a and 17d.

The LDD 13 is monitored and controlled by the controller 3 through the command line Tx_DISABLE provided from the CPU 3 to start or stop the emission of LDs, 11a to 11d. Each of the LDD units, 13a to 13d, provides modulation signals transmitted from the CDRs, 17a to 17d, to the LDDs, 11a to 11d. The signals transmitted from the CDRs, 17a to 17d, are reshaped by the CDRs, 17a to 17d. The modulation signals provided to the LDs, 11a to 11d, are modulation currents, while the LDDs, 13a to 13d, may provide bias currents to LDs, 11a to 11d. The LDD 13 sometimes provides a function to maintain the optical output levels of respective LDs, 11a to 11d, in constant, which we call the automatic power control (APC), by adjusting a magnitude of the bias current and that of the modulation current.

The ROSA 15 has a function to convert optical signals into electrical signals. The ROSA 15 includes four photodiodes (PDs), 15a to 15d, and an optical de-multiplexer 15e. Each of PDs, 15a to 15d, is connected to respective LIA units, 21a to 21d. The optical de-multiplexer 21e, which receives an external optical signal that contains four signals each having a wavelength different from others, de-multiplexes this optical signal into four optical signals depending on wavelengths thereof, and each of de-multiplexed optical signals enter respective PDs, 15a to 15d. Each of PDs, 15a to 15d, converts the de-multiplexed optical signal into an electrical signal and transmits thus converted electrical signals to respective LIAs, 21a to 21d.

The LIA 21 includes LIA units, 21a to 21d. Each of LIAs, 21a to 21d, is coupled with respective CDR units, 19a to 19d. The LIA 21 is connected to the bus selector 5 through one of the daughter serial bus Ch_D.

The LIA 21 is controlled under the controller 3 through the bus selector 5. As described, the LIA units, 21a to 21d, receive electrical signals from the PDs, 15a to 15d, and output amplified signals to respective CDR units, 19a to 19d.

The first CDR 17 includes four CDR units, 17a to 17d. Each of the CDR units, 17a to 17d, receives the transmitted signals from the outside of the optical transceiver 1. The CDR 17 is controlled from the controller 3 through the command line P_Down. Moreover, the CDR 17 is also coupled with the controller through two serial busses, Ch_A and Ch_0, and the bus selector 5.

Each of the CDR units, 17a to 17d, receives a signal to be transmitted. The signal may be a complementary signal, that is, the signal contains two components, Tx+ and Tx−, with phases different by 180° to the others. The CDR unit, 17a to 17d, extracts a clock from the signal, Tx+ and Tx−, and reshapes the signal Tx+ and Tx−, by thus extracted clock. The CDR units, 17a to 17d, provide the reshaped signal to respective LDD units, 13a to 13d.

The second CDR 19 also includes four CDR units, 19a to 19d. The second CDR 19 is also controlled from the controller by the command P_Down. Each of the CDR units, 19a to 19d, receives the amplified signals from respective LIA units, 21a to 21d, extracts a clock from the amplified signals, reshapes the amplified signals by thus extracted clock, and outputs the reshaped signal to the outside of the optical transceiver 1. The signals output from the second CDR 19 may be the differential configuration. Specifically, each of the CDR units, 19a to 19d, generates a signal with two components, Rx+ and Rx−, complementary to each other. The second CDR 19 also couples with the controller 3 through two serial busses, Ch_0 and Ch_A, and the bus selector 5.

The temperature sensor 7 monitors an inner temperature of the optical transceiver 1. The temperature sensor 7 also couples with the controller 3 through two serial busses, Ch_0 and Ch_C. The temperature sensor 7 transmits data regarding to measured temperatures to the controller 3 by putting them on the daughter serial bus Ch_C.

The bus selector 5 has the 1×4 arrangement, that is, one serial bus is able to couple with four serial busses, the former Ch_0 is called as the mother serial bus, while, the latters, Ch_A to Ch_D, are called as the daughter serial busses in this specification. As described later, the selection of the daughter serial buses, Ch_A to Ch_D, namely, which daughter serial bus is to be coupled with the mother serial bus, may be controlled by the controller 3 using the mother serial bus Ch_0.

The controller 3 monitors statuses within the optical transceiver 1 and controls respective units, 7 to 21, in the optical transceiver 1 depending on the monitored statuses. Specifically, the controller 3 stops or starts the TOSA 11 and the ROSA 15, sets the transmission speed, and so on.

The controller 3 communicates with the host device through control lines that contains, for instance, a command to set the optical transceiver 1 in the power saving mode, an alarm indicating a status where some failures, such as a loss of optical signal (LOS), another alarm where LDs is provided with an excess bias current to emit light with a preset amplitude, and so on, are observed within the optical transceiver 1, and so on. The control lines also include an external serial bus with two- or three-wired arrangement.

The controller 3 provides the internal command lines, one of which is Tx_DISABLE to stop the emission of the LDs, 11a to 11d, forcibly, and the other is P_Down to stop the supplement of the power supply to two CDRs, 17 and 19. Receiving the command to set the optical transceiver 1 in the power saving mode from the host device, the controller 3 asserts the command line P_Down and two CDRs are stopped to be provided with the power supply.

FIG. 2 extracts units around the inner serial busses, Ch_0 to Ch_D, and a power switch. As described, the circuit units, 7 to 21, are coupled with the controller 3 through respective daughter serial busses, Ch_A to Ch_D, the bus selector 5, and the mother serial bus Ch_0. In addition, two CDRs, 17 and 19, where they are connected to the common daughter serial bus Ch_A, are provided with the power supply Vcc_CDR that is switchable by a MOSFET 23 which is controlled by the command line P_Down.

In an normal operation, the controller 3 negates the command P_Down to turn the MOSFET 23 on, which provides the power supply Vcc_CDR to the CDRs, 17 and 19. Although the power supply Vcc_CDR is lowered from the source power supply Vcc by a turn-on voltage of the MOSFET, the turn-on voltage is ignorable to operate the CDRs, 17 and 19. When the controller 3 receives the command to set the optical transceiver 1 in the power saving mode, the controller 3 asserts the command P_Down to turn the MOSFET 23 off, which substantially isolates the secondary power supply Vcc_CDR from the primary power supply Vcc and sets the secondary power supply Vcc_CDR to be substantially zero. Thus, two CDRs, 17 and 19, in an operation thereof are fully killed to save the power thereof.

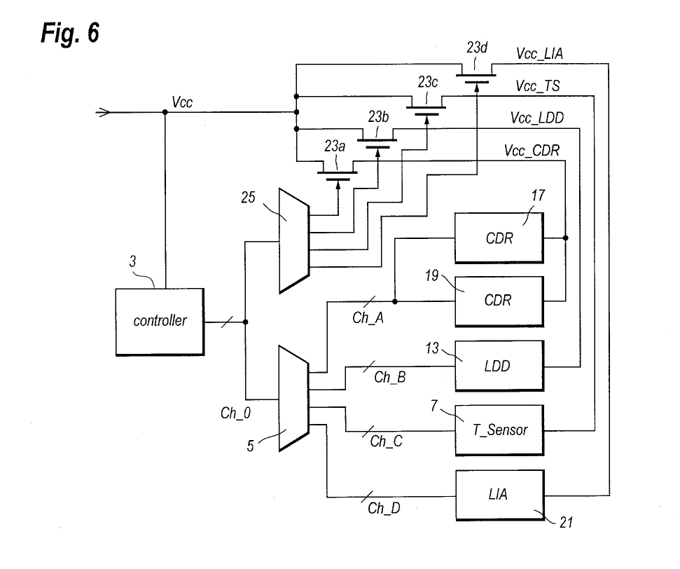

FIG. 6 shows a modification of the circuit units connected to the daughter serial busses. The circuit units, 7 to 21, shown in FIG. 6 are also connected to the bus selector 5 through respective daughter serial busses, Ch_A to Ch_D, same as those shown in FIG. 2. However, the circuit units, 7 to 21, in FIG. 6 are provided with a power supply independently. That is, the temperature sensor 7 is provided with the power supply Vcc_TS, the LDD 13 is provided with the power supply Vcc_LDD, the LIA is provided with the power supply Vcc_LIA, and the CDRs are supplied with the power supply Vcc_CDR. These power supplies are originated from the primary power supply Vcc through respective MOSFETs, 23a to 23d. These MOSFETs, 23a to 23d, are controlled by the controller 3 through the data expander 25. The data expander 25 is coupled with the controller 3 through the mother serial bus Ch_0 and provides four outputs each provided to respective gates of the MOSFETs, 23a to 23d. Under the control of the controller 3, the data expander turns on/off the MOSFETs, 23a to 23d, by which respective circuit units are provided with the power supplies.

FIG. 3 shows protocols of the I²C communication between the controller 3 and the bus selector 5. In WRITE mode from the controller 3, the protocol set by the controller 3 first defines the slave address of the bus selector 5, which is assumed to be “E0h”, sets the flag corresponding to WRITE mode to be “0”, and finally sets a control data with 8 bits. Each of the bits of the control data corresponds to one of daughter serial buses, Ch_A to Ch_D. For instance, when the controller 3 couples the mother serial bus Ch_0 with the daughter serial bus Ch_A, the LSB (least significant bit) is set in the control data. The controller 3 then puts a frame including the slave address of the circuit unit connected to the daughter serial bus Ch_A, the CDRs in this case, the operation mode, and a data to be set in the circuit unit when the mode is WRITE, or a data denoting the status of the circuit unit when the mode is READ. Thus, the controller 3 may communicate with the circuit unit connected to the daughter serial bus Ch_A through two I²C buses.

When the mode is READ, the controller 3 first sets the slave address “E0h” of the bus selector 5 and the operation mode “1” denoting READ mode. The bus selector 5 prepares the status code of the daughter serial bus currently coupling with the mother serial bus Ch_0. Specifically, when two of daughter serial busses, Ch_B and Ch_C, are couples with the mother serial bus Ch_0, the bus selector 5 prepares the status code of “05h”, and the controller 3 recognizes which daughter serial busses, Ch_A to Ch_D, is coupled with the mother serial bus Ch_0. When a daughter serial bus connected to a target circuit unit to be communicated with the controller 3 is currently coupled with the mother serial bus Ch_0, the controller 3 subsequently sends a frame including a slave address of the target circuit unit, the operation mode, and a data to be written in the circuit unit when the operation mode is WRITE. While, a daughter serial bus connected to the target circuit unit is inactive, the controller 3 then writes the control code described above to connect the daughter serial bus with the mother serial bus Ch_0. Thus, the controller 3 may communicate with the target circuit unit through two I²C buses.

Next, an operation of the optical transceiver 1 will be described. The optical transceiver 1 of the embodiment, at the starting thereof, only activates the mother serial bus Ch_0; while daughter serial busses extending from the bus selector 5 are left inactive. That is, the controller 3 only communicates with the bus selector 5 by the mother serial bus Ch_0. Sending a command to the bus selector 5 from the controller 3, the bus selector 5 activates one of daughter serial buses selected by the controller 3, and the controller 3 becomes able to communicate with one of circuit units coupled with the selected daughter serial bus.

The optical transceiver 1 is set in the power saving mode at the start-up. The power saving mode cuts off the power supply from two CDRs, 17 and 19, and asserts Tx_DISABLE provided to the LDD 13, that is, the LDD 13 is inhibited to provide signals to the TOSAs. Referring to FIG. 4, the controller 3 first selects the temperature sensor 7 by coupling the daughter serial bus Ch_C with the mother serial bus Ch_0 and collects statuses of the temperature sensor 7 and set parameters thereto. Second, the controller 3 selects the LDD 13 by connecting the daughter serial bus Ch_B with the mother serial bus Ch_0 to initialize the LDD 13. In this status, both the daughter serial busses, Ch_C and Ch_D, are coupled with the mother serial bus Ch_0. Third, the controller 3 additionally selects the LIA 21 by coupling the daughter serial bus Ch_D with the mother serial bus Ch_0 to set parameters thereto and collect LOS status therefrom through the bus selector 5. The daughter serial busses, Ch_B to Ch_D, are commonly coupled with the mother serial bus Ch_0. Finally, being triggered with the resetting of the power saving mode, the controller negates the command P_Down to provide the power supply to respective CDRs, 17 and 19; then, the controller 3 couples the daughter serial bus Ch_A with the mother serial bus Ch_0 to set parameters to the CDRs, 17 and 19, and collect statuses including alarm flags from the CDRs, 17 and 19. After the start-up procedures described above, although all daughter serial busses, Ch_A to Ch_D, are commonly coupled with the mother serial bus Ch_0, the controller 3 may communicate with circuit units, 11 to 21, by distinguish device addresses thereof. That is, respective circuit units, 11 to 21, are given with a device address unique to the circuit unit and different from the addresses of other circuit units.

During the stable operation of the optical transceiver 1, the controller periodically changes the daughter serial busses, Ch_A to Ch_D, coupled with the mother serial bus Ch_0, and sets parameters in and collets statuses from respective units coupled with daughter serial bus selected from the controller 3. The frequency of the selection of one of daughter serial busses, Ch_A to Ch_D, is optional depending on the units. Moreover, the period of the selection is unnecessary to be common to respective units. For instance, the selection for the temperature sensor 7 is able to be frequent compared with the selection of other units.

When the optical transceiver 1 is triggered externally to enter the power saving mode, the controller 3 sets the daughter serial bus Ch_A inactive and asserts the flag P_Down to suspend the power supply to the CDRs, 17 and 19. However, other daughter serial busses, Ch_B to Ch_D, are kept active. The controller 3 may set parameters in and collect statues from respective units. Thus, the optical transceiver 1 provides the configuration where the internal serial bus coupling the controller with circuit units is divided into two parts, namely, the mother serial bus Ch_0 and the daughter serial busses, Ch_A to Ch_D. Accordingly, the controller 3 may communicate with some of circuit units through the serial busses even the controller 3 receives a command from the host device to enter the power saving mode.

### Second Embodiment

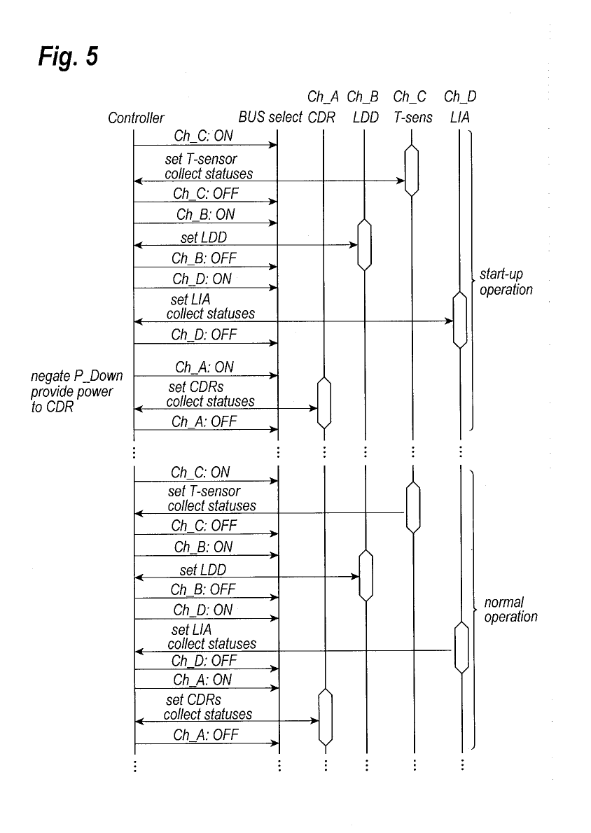

FIG. 5 shows a sequence to control the optical transceiver 1 according to the second embodiment of the invention. The controller 1 in the present embodiment activates only one of the daughter serial busses, Ch_A to Ch_D, connected to the target circuit unit to be communicated with the controller 3. Specifically, at the start-up of the optical transceiver 1, the controller 3 first connects the daughter serial bus Ch_C with the mother serial bus Ch_0 to set parameters in and collects statues or a measured internal temperature of the optical transceiver 1 from the temperature sensor 7; then, the controller 3 isolates the daughter serial bus Ch_C from the mother serial bus Ch_0. Subsequently, the controller 3 connects respective daughter serial busses, Ch_B, Ch_D and Ch_A, to the mother serial bus Ch_0 sequentially and independently to set parameters in and collect statuses from respective circuit units, 13, 17, 19 and 21.

Similar to the start-up sequence of the optical transceiver 1 described above, the controller 3 connects one of daughter serial busses, Ch_A to Ch_D, to the mother serial bus Ch_0, sequentially and independently to set parameters in and collect statuses from respective circuit units, 7 to 21. According to the embodiment thus described, only one of the daughter serial busses, Ch_A to Ch_D, is selectively coupled with the mother serial bus Ch_0, respective circuit units, 7 to 21, may be assigned in device addresses same to each other. Moreover, even some of the circuit units fall in failure and the daughter serial bus connected to these circuit units are hung to prevent further communication, the controller 3 may communicate with rest of the circuit units may communicate with the controller 3 by releasing those daughter serial busses from the mother serial bus Ch_0 by controlling the bus selector 5.

The identification of the devices to be fallen in failures are carried out by, for instance, when the controller 3 selects one of the daughter serial busses connected to the device in the failure, the daughter serial bus causes no changes in the level thereof. Or, when the controller sends a data as defining the device address of the circuit units, but receives only “NACK”; then the controller 3 may decide that the circuit unit under consideration causes some failures.

While there has been illustrated and described what are presently considered to be example embodiments of the present invention, it will be understood by those skilled in the art that various other modifications may be made, and equivalents may be substituted, without departing from the true scope of the invention. Additionally, many modifications may be made to adapt a particular situation to the teachings of the present invention without departing from the central inventive concept described herein. Therefore, it is intended that the present invention not be limited to the particular embodiments disclosed, but that the invention include all embodiments falling within the scope of the appended claims.

What is claimed is:

1. A method to control an electronic apparatus that implements with a mother serial bus, a plurality of daughter serial buses each selectively coupled with the mother serial bus, and a plurality of circuit units each coupled with respective daughter serial buses, the method comprising steps of:
selecting one of circuit units by providing power supply thereto;
selecting one of daughter serial busses coupled with one of the circuit units; and
communicating with one of the circuit units with the one of the daughter serial busses, the bus selector, and the mother serial bus.

2. The method of claim 1,
further including a step, after the communication with one of the circuit units, releasing the one of the daughter serial buses coupled with one of the circuit units.

3. The method of claim 2,
wherein at least two circuit units have a device address same to each other.

4. The method of claim 1,
further including a step, after the communication with one of the circuit units, selecting another of daughter serial busses coupled with another of the circuit units without releasing one of the daughter serial buses.

5. The method of claim 4,
wherein the one of the circuit units has a device address different from the another of circuit units selected after the communication with one of the circuit units.

6. An optical transceiver coupled with a host system, comprising:
a plurality of circuit units;
a bus selector;
a controller; and
a mother serial bus configured to couple the controller with the bus selector and a plurality of daughter serial busses each being configured to couple the bus selector with respective circuit units,
wherein the controller cuts a supplement of a power supply to at least one of the circuit units and isolates one of the daughter serial busses coupled to the at least one of the circuit units by controlling the bus selector.

7. The optical transceiver of claim 6,
wherein the controller cuts the supplement of the power supply in response to a command to save power of the optical transceiver sent from the host system.

8. The optical transceiver of claim 6,
wherein the mother serial bus and the daughter serial busses are a type of I²C serial bus.

9. The optical transceiver of claim 6,
wherein respective circuit units including the bus selector have a unique device address different from others.

10. The optical transceiver of claim 6,
wherein at least two circuit units each coupled with respective daughter serial busses have device addresses common to each other.

11. The optical transceiver of claim 6,
further including a MOSFET to cut the supplement of the power supply,
wherein the MOSFET is controlled from the controller.

12. The optical transceiver of claim 6,
wherein at least one of circuit units is a temperature sensor to sense an inner temperature of the optical transceiver.

13. The optical transceiver of claim 6
wherein at least one of circuit units is a clock data recovery (CDR) to be cut with the supplement of the power supply, the CDR reshaping input electrical signals externally provided to the optical transceiver, or output electrical signals converted from an input optical signal.

14. The optical transceiver of claim 6
further including a transmitter optical assembly (TOSA), a receiver optical assembly (ROSA), a laser diode driver (LDD), and a limiting amplifier (LIA) as the circuit units,
wherein the TOSA, the ROSA, the LDD, and the LIA have a configuration of four lanes each operating in parallel to each other.
